(19) United States
(12) Patent Application Publication
(10) Pub. No.: US 2006/0245649 A1
(43) Pub. Date: Nov. 2, 2006

(54) Method and system for recognizing objects in an image based on characteristics of the objects

(75) Inventors: Mei-Ju Chen, Hsinchu Hsien (TW); Tzu-Yi Chao, Hsinchu Hsien (TW); Yi-Fang Lee, Hsinchu Hsien (TW)

Correspondence Address: HARNESS, DICKEY, & PIERCE, P.L.C, 7700 BONHOMME, STE 400, ST. LOUIS, MO, 63105, US

(73) Assignee: Pixart Imaging Inc.

(21) Appl. No.: 11/409,585

(22) Filed: Apr. 24, 2006

(30) Foreign Application Priority Data
May 2, 2005 (TW) 094114117

(51) Int. Cl. G06K 9/34

(52) U.S. Cl. 382/173

(57) ABSTRACT

A characteristics-based image recognition method for recognizing objects in an image is implemented using an image sensor and a register. The image sensor has a plurality of pixel sensing elements. The method includes: setting a grayscale threshold value of the image; acquiring pixel values of each row sequentially in the image; identifying a background region and linear image segments of the objects in the image according to the grayscale threshold value; identifying the objects to which the linear image segments belong according to a spatial correlation between a newly detected linear image segment and a previously detected linear image segment; associating collected information of the linear image segments with the identified objects to which the linear image segments belong; and distinguishing the identified objects from each other based on solid, ring-shaped, long and short characteristics.

### CROSS-REFERENCE TO RELATED APPLICATION

This application claims priority of Taiwanese Application No. 094114117, filed on May 2, 2005.

### BACKGROUND OF THE INVENTION

1. Field of the Invention

The invention relates to an image recognition method, more particularly to a method and system for recognizing objects in an image based on characteristics of the objects.

2. Description of the Related Art

Playing television games and PC games are common recreational activities nowadays. Take a conventional PC game as an example. Game software is installed in a computer, and is controlled via an input interface, such as a keyboard, a mouse, a joystick, etc., in combination with a screen of the computer. However, there are also available interactive tools for use in conjunction with the game software. For purposes of illustrating the structure and working principle of such interactive tools, an interactive game device disclosed in U.S. Patent Publication No. 20040063481 is used as an example herein.

Referring to FIG. 1, an interactive game device 700 has two dumbbell-shaped marking devices 71, 72, a dancing pad 720, a screen device 730, a video camera 750, an input computing device 760, and a game computing device 770. The game computing device 770 has game software installed therein. The marking devices 71, 72 are to be held by left and right hands of a user 705, and have light sources 711, 712 and 721, 722 at end portions thereof, respectively. The screen device 730 displays an image of a virtual character, such as a virtual dancer 731, in the game software. The game computing device 770 can be a personal computer or a game console machine. The screen device 730 and the input computing device 760 are connected respectively to the game computing device 770.

When the aforesaid interactive game device 700 is used to play a dancing game, the user 705 needs to turn on the marking devices 71, 72 to activate the respective light sources 711, 712 and 721, 722 to emit light so as to enable the video camera 750 to capture images that contain the light sources 711, 712 and 721, 722. The input computing device 760 computes parameters, such as positions of the light sources 711, 712 and 721, 722, for input into the game computing device 770 to track the positions of the light sources 711, 712 and 721, 722 of the marking devices 71, 72 held by the user 705 and to control movement of the virtual dancer 731 on the screen device 730 accordingly.

### SUMMARY OF THE INVENTION

The object of the present invention is to provide a method and system for recognizing objects in an image based on solid, ring-shaped, long and short characteristics of the objects, which can facilitate distinguishing among different objects in an image.

Accordingly, the method for recognizing objects in an image of the present invention is implemented using an image sensor and a register. The image sensor includes a plurality of pixel sensing elements arranged in rows and capable of sensing the image in a row-by-row manner such that linear image segments of the objects in the image captured by the image sensor are sensed by corresponding rows of the pixel sensing elements. The method includes the following steps: (A)setting a grayscale threshold value of the image; (B) acquiring pixel values of each row sequentially in the image; (C) identifying a background region and the linear image segments in the image according to the grayscale threshold value; (D) identifying the objects to which the linear image segments belong according to a spatial correlation between a newly detected linear image segment in a currently inspected row of the image and a previously detected linear image segment in an adjacent previously inspected row of the image; (E) associating collected information of the linear image segments with the identified object to which the linear image segments belong; and (F) distinguishing the identified objects from each other based on at least one object characteristic.

According to another aspect, the system for recognizing objects in an image of the present invention includes: an image sensor including a plurality of pixel sensing elements arranged in rows and capable of sensing the image in a row-by-row manner such that linear image segments of the objects in the image captured by the image sensor are sensed by corresponding rows of the pixel sensing elements, the image sensor outputting the linear image segments as an analog output; an analog-to-digital converter connected to the image sensor for converting the analog output to a digital output; an image processor connected to the analog-to-digital converter and collecting information of the linear image segments from the digital output, the image processor being set with a grayscale threshold value of the image; and a register connected to the image processor for temporary storage of the information of the objects collected by the image processor. The image processor identifies a background region and the linear image segments in the image according to the grayscale threshold value, identifies the object to which a newly detected linear image segment located in a currently inspected row of the image belongs according to a spatial correlation between the newly detected linear image segment and a previously detected linear image segment in an adjacent previously inspected row of the image, associates the collected information of the linear image segments with the identified objects, and distinguishes the identified objects from each other based on at least one object characteristic.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional interactive game device;

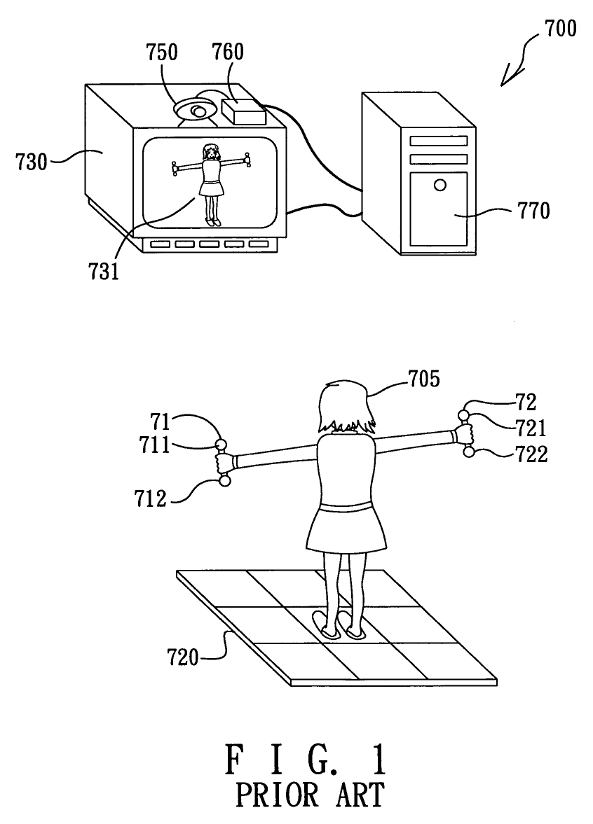

FIG. 2 is a circuit block diagram showing an image recognition system for implementing the method for recognizing objects in an image according to the present invention, the system being adapted to provide information related to identified objects to a conventional personal computer via a transmission interface;

FIG. 3 is a schematic diagram showing how the first preferred embodiment of the method for recognizing objects in an image according to the present invention can be used to distinguish between solid and ring-shaped objects in an image;

FIG. 4 is a flowchart of the steps for identifying objects in an image in the method according to the present invention;

FIG. 5 is a flowchart showing how objects in an image are identified to be a solid or ring-shaped object;

FIG. 6 is another schematic diagram showing how the first preferred embodiment can be used to distinguish between solid and ring-shaped objects in the image;

FIG. 7 is a flowchart of the second preferred embodiment of the method for recognizing objects in an image according to the present invention; and

FIG. 8 is a schematic diagram showing how the second preferred embodiment can be used to distinguish between long and short objects in an image.

### DETAILED DESCRIPTION OF THE PREFERRED EMBODIMENTS

Before the present invention is described in greater detail, it should be noted that like elements are denoted by the same reference numerals throughout the disclosure. In addition, it is noted that while the first preferred embodiment of this invention is exemplified using solid and ring-shaped characteristics, and while the second preferred embodiment of this invention is exemplified using long and short characteristics, in other embodiments, such solid, ring-shaped, long and short characteristics can be used in combination. Therefore, any application having the aforesaid characteristics should be deemed to fall within the scope intended to be protected by the concept of this invention.

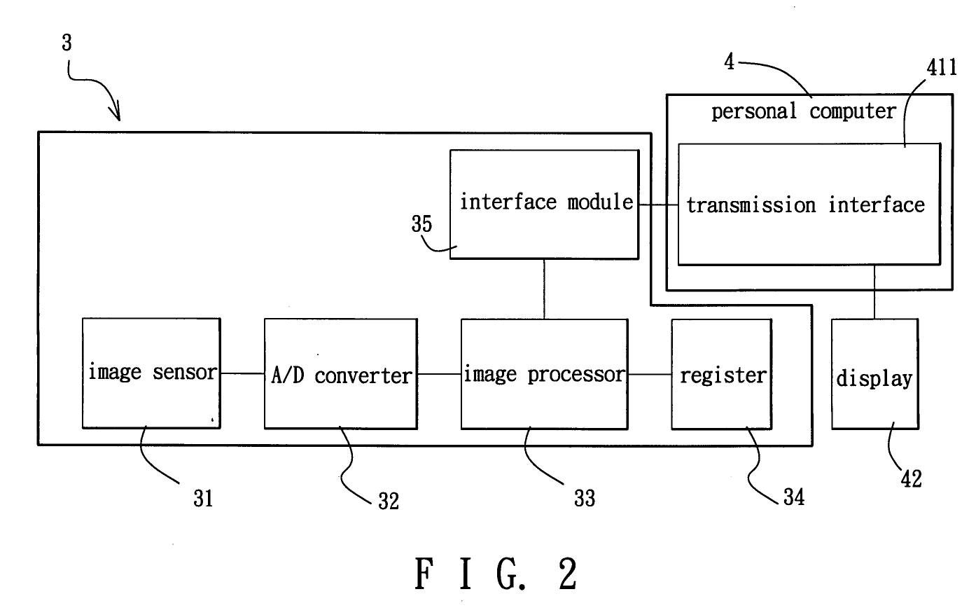

Referring to FIG. 2, in the two preferred embodiments of the method for recognizing objects in an image based on characteristics of the objects according to this invention, the method is implemented using a system which is an image processing system 3. The image processing system 3 has an image sensor 31, an analog-to-digital converter (A/D converter) 32, an image processor 33, a register 34, and an interface module 35.

The image sensor 31 may be a CCD or CMOS element, and has a plurality of rows of sensing pixels for sensing light rays from captured objects (not shown) so as to form an image. Furthermore, the image sensor 31 senses the objects using the sensing pixels so as to form a plurality of linear image segments (the function of which will be described hereinafter) contained in an analog signal. The analog signal is then outputted to the A/D converter 32 that is connected to the image sensor 31 for conversion to a digital signal. The image processor 33 is responsible for signal processing and computations. The image processor 33 is connected to the A/D converter 32, processes the signals sensed by the sensing pixels row by row for computing the signals, and is set with a grayscale threshold value and a determination rule for distinguishing characteristics of the objects. The register 34 is connected to the image processor 33 for temporary storage of information of the objects collected by the image processor 33.

The image processor 33 identifies a background region and the linear image segments in the image according to the grayscale threshold value. The image processor 33 further identifies the object to which a newly detected linear image segment located in a currently inspected row of the image belongs according to a spatial correlation between the newly detected linear image segment and a previously detected linear image segment in an adjacent previously inspected row of the image, associates collected information of the newly detected linear image segment with the object to which the newly detected linear image segment belongs, and distinguishes the identified objects from each other based on at least one object characteristic. Recognition of the characteristics of the objects in the image is conducted after all the pixel values of the image have been acquired by the image processor 33.

The interface module 35 of the image processing system 3 is connected to the image processor 33, and serves to output information related to the identified objects in a data format complying with a peripheral protocol of a computer. For example, a signal which has been converted to a USB-compliant format is outputted to a transmission interface 411 of a personal computer 4. The personal computer 4 receives and computes the signal, and displays the identified objects on a display 42 thereof.

It is noted that the image processing system 3 can be used in an image capturing device, such as a video camera, to provide the same with an image recognition function, or may be implemented as image recognition software installed in a computer. In addition, since the structures of the image sensor 31, the A/D converter 32, and the image processor 33 are well known in the art, and since the crucial feature of the present invention resides in the use of the image processor 33 in combination with the register 34 to perform the image recognition function, only those components which are pertinent to the feature of the present invention will be discussed in the succeeding paragraphs.

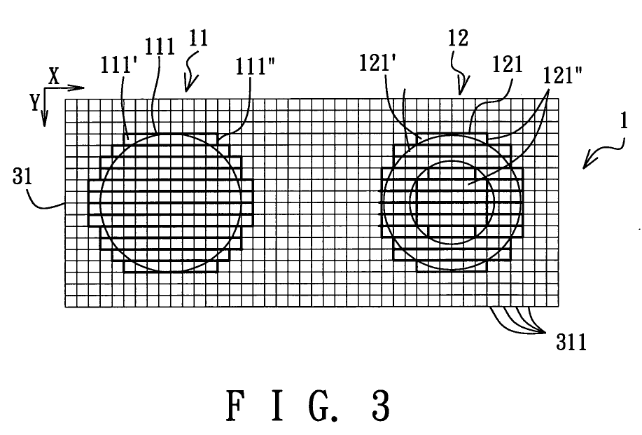

FIGS. 2 and 3 illustrate the first preferred embodiment of the method for recognizing objects in an image 1 according to the present invention. In this preferred embodiment, the image 1 has objects to be recognized, which are exemplified herein using a solid object 11 and a ring-shaped object 12. The image sensor 31 has a plurality of pixel sensing elements 311 that are arranged in rows, and that are capable of sensing the image 1 in a row-by-row manner such that linear image segments of the objects 11, 12 in the image 1 captured by the image sensor 31 are sensed by corresponding rows of the pixel sensing elements 311. The recognition of the linear image segments is to determine a start point of each of the linear image segments in a currently inspected row for storage in the register 34. Information of each linear image segment is collected point-by-point starting from the start point and is stored in the register 34. Then, an end point of each linear image segment is determined and is stored in the register 34.

For instance, the image processing system 3 will first acquire pixel values of the image 1 as sensed by each row of the sensing pixels 311 from the image sensor 31 in sequence for conversion by the A/D converter 32 to digital signals that are inputted into the image processor 33. The pixel values are inspected row by row starting from the first row, from left to right, and from top to bottom. Presence of image information of an object is determined when presence of a pixel value that is greater than the grayscale threshold value is detected.

During the inspection process, the start points and the endpoints of the linear image segments of the objects in each row can be concurrently determined. Then, the object to which the newly detected linear image segment is identified using the spatial correlation (to be described hereinafter) between the newly detected linear image segment and a previously detected linear image segment in an adjacent previously inspected row of the image. For instance, in FIG. 3, image information of objects appears in the fourth row of the image 1. The image information belongs to two objects 11, 12. Therefore, starting from the left of the row to the right, a start point 111′ of a first linear image segment 111 is determined and stored in the register 34, and information of the linear image segment 111 is collected point-by-point and is stored in the register 34. Then, an end point 111″ of the linear image segment 111 is determined and stored in the register 34. In the same manner, start and end points 121′, 121″, as well as point-by-point information, of another linear image segment 121 in the same row are stored in the register 34. Inspection of the image 1 thus proceeds in this manner row by row.

Identification of the objects to which the linear image segments belong is performed according to a spatial correlation of the linear image segments in two adjacent rows. A newly detected linear image segment is determined to belong to an object I if the following equations are satisfied:
Seg-L≦Preline-Objᵢ-R; and
Seg-R≧Preline-Objᵢ-L Equation 1
where, assuming that the y^{th} row of the image 1 is currently being inspected, Seg-L represents the X-axis coordinate of a left start point of the newly detected linear image segment found in the y^{th} row; Seg-R represents the X-axis coordinate of a right end point of the newly detected linear image segment found in the y^{th} row; Preline-Objᵢ-R represents the X-axis coordinate of a right end point of a previously detected linear image segment of the object i that was found in the (y−1)^{th} row of the image 1; and Preline-Objᵢ-L represents the X-axis coordinate of a left start point of the previously detected linear image segment of the object i that was found in the (y−1)^{th} row. If the equations Seg-L≦Preline-Objᵢ-R and Seg-R≧Preline-Objᵢ-L are satisfied, this indicates that the newly detected linear image segment belongs to the same object i to which the previously detected linear image segment also belongs.

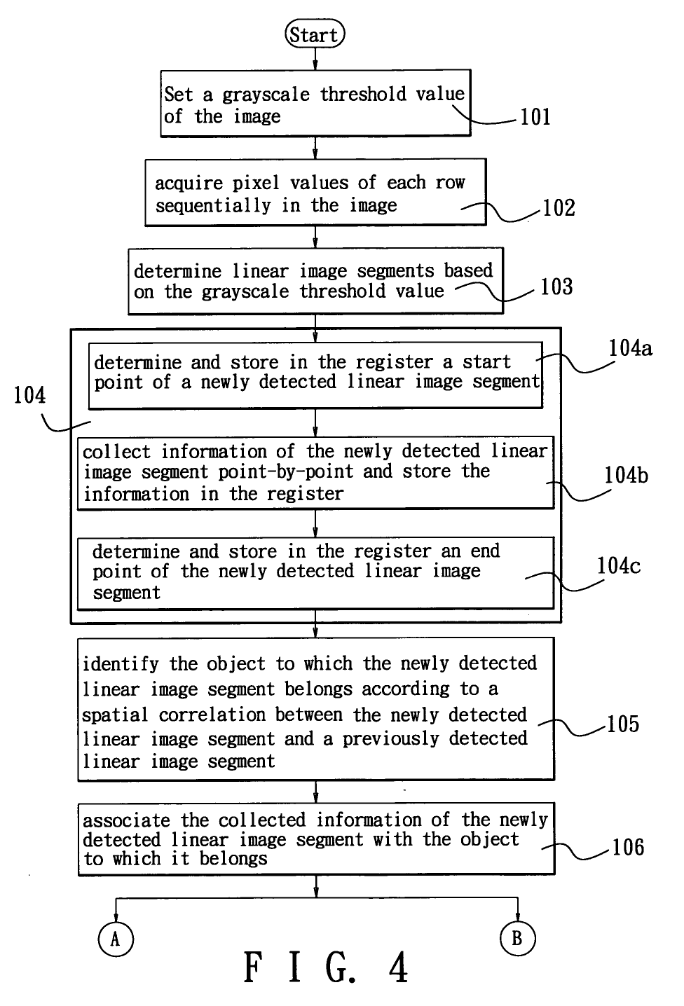

Referring to FIG. 4, the steps of, as well as the principles behind, the identification of objects to which detected linear image segments belong in the two preferred embodiments of the invention will now be described in detail as follows:

Initially, in step 101, a grayscale threshold value of the image 1 is set. The grayscale threshold value is used to distinguish objects in the image 1 from a background region of the image 1. Then, in step 102, pixel values of each row in the image 1 are acquired sequentially. In step 103, linear image segments are determined based on the grayscale threshold value. In step 104, the objects to which the respective linear image segments belong are identified. The identification step includes a sub-step 104a of determining and storing in the register a start point of a newly detected linear image segment, a sub-step 104b of collecting information of the newly detected linear image segment point-by-point starting from the start point and storing the information in the register 34, and a sub-step 104c of determining and storing in the register an end point of the newly detected linear image segment. Then, in step 105, the object to which the newly detected linear image segment belongs is identified according to a spatial correlation between the newly detected linear image segment and a previously detected linear image segment in an adjacent previously inspected row of the image 1. In step 106, the collected information of the newly detected linear image segment is associated with the object to which it belongs. Inspection of another linear image segment in the same row is performed in the same manner until all the linear image segments in the image 1 are inspected.

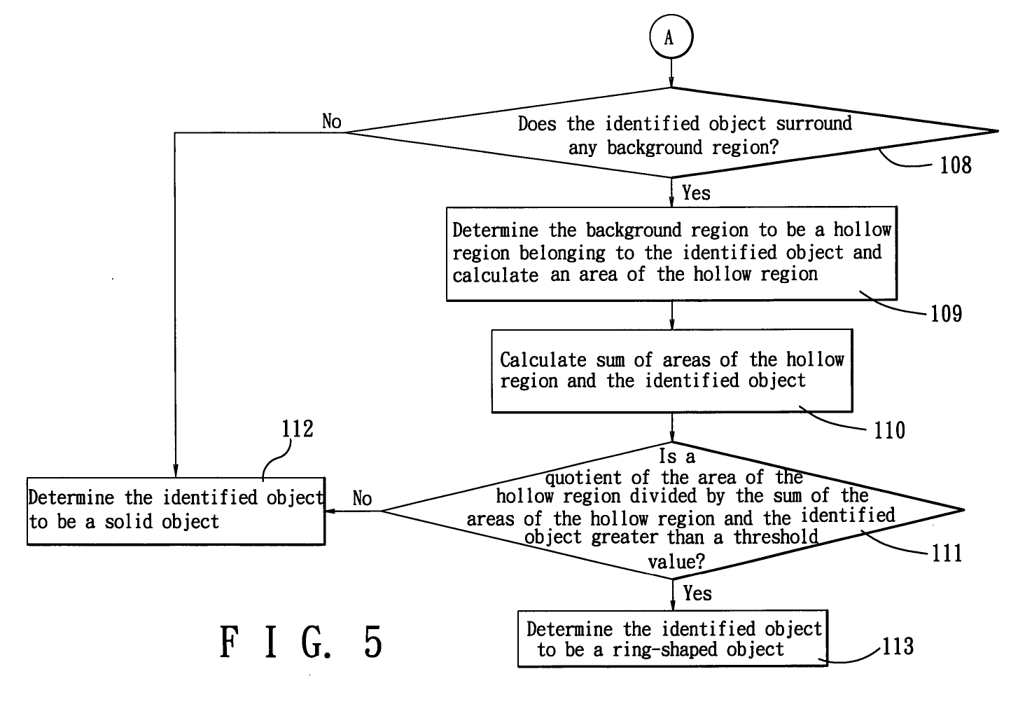

With reference to FIGS. 4 and 5, the first preferred embodiment of a method for recognizing objects in an image according to this invention is adapted to distinguish solid and ring-shaped objects from each other, and includes the following steps:

Initially, steps 101 to 106 are performed to identify the objects in the image 1 to which the detected linear image segments respectively belong. Then, each identified object is inspected to determine whether the identified object has a solid or ring-shaped characteristic according to the following steps. In step 108, it is determined whether the identified object surrounds any background region. If it is determined that the identified object does not surround any background region, it is determined in step 112 that the object has a solid characteristic and is therefore a solid object. If it is determined in step 108 that the identified object surrounds a background region, in step 109, the background region is determined to be a hollow region belonging to the identified object, and an area of the hollow region is calculated. Sum of areas of the hollow region and the identified object is further calculated in step 110.

Subsequently, in step 111, it is determined whether a quotient of the area of the hollow region divided by the sum of the areas of the hollow region and the identified object is greater than a threshold value. In this preferred embodiment, the threshold value is preferably 0.05-0.08. If the quotient thus calculated in step 111 is not greater than the threshold value, step 112 is performed to determine the identified object as a solid object. Otherwise, in step 113, the identified object is determined to be a ring-shaped object.

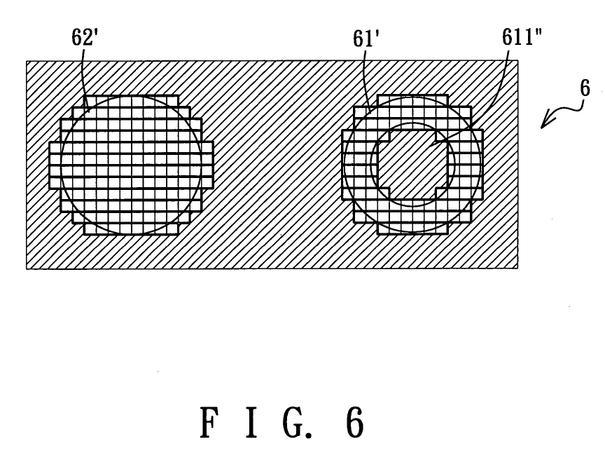

Referring to FIG. 6, to further illustrate, in the first preferred embodiment of the present invention, an image 6 is binarized using the grayscale threshold value. Then, pixel values of the image 6 are inspected row by row to detect linear image segments for identifying objects 61′, 62′ in the image 6. That is, linear image segments of the objects 61′, 62′ will be first identified according to steps 104-106 described above. Next, the objects 61′, 62′ are identified to be solid or ring-shaped by determining whether the objects 61′, 62′ surround a background region. As shown, the object 62′ is a solid object, whereas the object 61′ surrounds a background region 611″, and is therefore a ring-shaped object.

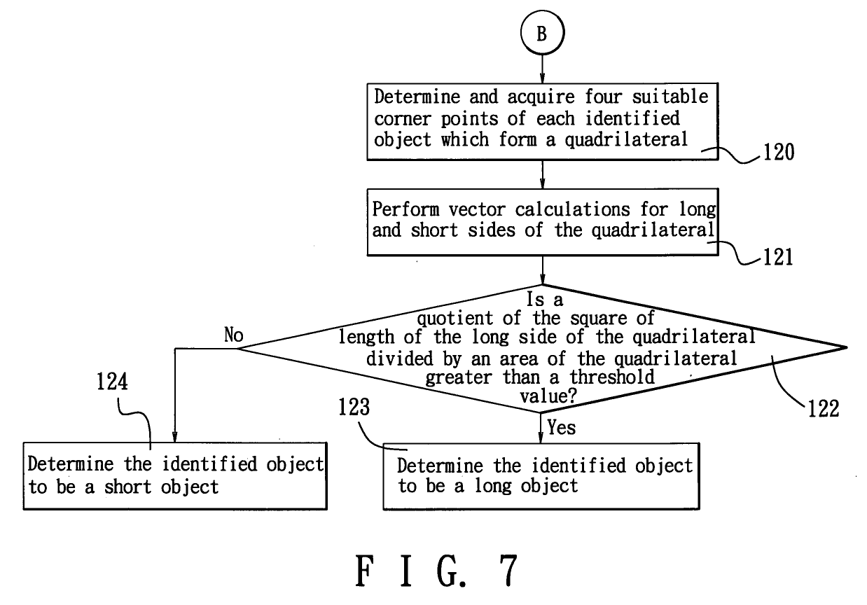

Referring to FIGS. 4 and 7, the second preferred embodiment of a method for recognizing objects in an image according to the present invention is adapted to distinguish long and short objects in an image from each other. The second preferred embodiment includes the following steps:

Initially, steps 101-106 are performed to determine linear image segments and to identify the objects to which the linear image segments belong. Then, characteristics of the identified objects are determined according to the following steps. As shown in FIG. 7, coordinates of four suitable corner points of each identified object which form a virtual quadrilateral are determined and acquired in step 120. Then, vector calculations for the long and short sides of the quadrilateral are performed in step 121. In step 122, it is determined whether a quotient of the square of length of the long side of the quadrilateral divided by an area of the quadrilateral is greater than a threshold value. If yes, step 123 is performed to determine the identified object to be a long object. Otherwise, step 124 is performed to determine the identified object to be a short object. Preferably, the threshold value is between 2 and 3.

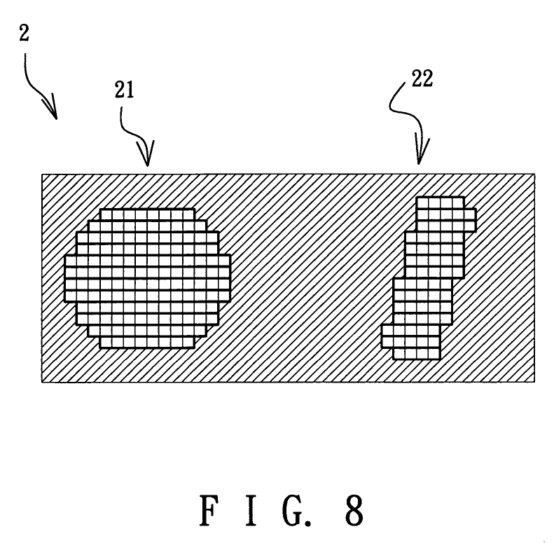

Referring to FIG. 8, two objects 21, 22 in an image 2 can be identified to be a short object and a long object, respectively, using the second preferred embodiment of this invention.

In sum, the present invention provides a method and system for recognizing objects in an image based on characteristics of the objects. In the present invention, by employing a grayscale threshold value to initially determine a background region and linear image segments of objects in an image, by using a spatial correlation to identify the objects to which the linear image segments belong, and by determining the identified objects to have a solid, ring-shaped, long or short characteristic, real-time object recognition can be achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for recognizing objects in an image, said method being implemented using an image sensor and a register, the image sensor including a plurality of pixel sensing elements arranged in rows and capable of sensing the image in a row-by-row manner such that linear image segments of the objects in the image captured by the image sensor are sensed by corresponding rows of the pixel sensing elements, said method comprising the following steps:
(A) setting a grayscale threshold value of the image;
(B) acquiring pixel values of each row sequentially in the image;
(C) identifying a background region and the linear image segments in the image according to the grayscale threshold value;
(D) identifying the objects to which the linear image segments belong according to a spatial correlation between a newly detected linear image segment in a currently inspected row of the image and a previously detected linear image segment in an adjacent previously inspected row of the image;
(E) associating collected information of the linear image segments with the identified objects to which the linear image segments belong; and
(F) distinguishing the identified objects from each other based on at least one object characteristic.

2. The method as claimed in claim 1, wherein step (F) includes the following sub-steps:
(G1) determining whether the identified object surrounds the background region;
(G2) determining the identified object to be a solid object when the identified object does not surround the background region, and otherwise determining the identified object to include a hollow region when the identified object surrounds the background region;
(G3) calculating a quotient of an area of the hollow region divided by a sum of areas of the hollow region and the identified object; and
(G4) determining the identified object to be a ring-shaped object if the quotient is greater than a threshold value, and otherwise determining the identified object to be a solid object.

3. The method as claimed in claim 1, wherein step (F) includes the following sub-steps:
(H1) determining coordinates of four suitable corner points of the identified object which form a quadrilateral;
(H2) performing vector calculations for long and short sides of the quadrilateral;
(H3) calculating a quotient of square of length of the long side of the quadrilateral divided by an area of the quadrilateral; and
(H4) determining the identified object to be a long object when the quotient is greater than a threshold value, and otherwise determining the identified object to be a short object.

4. The method as claimed in claim 1, wherein step (C) includes the following sub-steps:
(C1) determining and storing in the register a start point of the newly detected linear image segment located in the currently inspected row of the image;
(C2) collecting information of the newly detected linear image segment point-by-point starting from the start point, and storing the information in the register; and
(C3) determining and storing in the register an end point of the newly detected linear image segment.

5. The method as claimed in claim 1, wherein, in step (D), the object to which the newly detected linear image segment belongs is identified based on the following equations such that the newly detected linear image segment is determined to belong to the object i when the following equations are satisfied:
Seg-L≦Preline-Objᵢ-R; and
Seg-R≧-Preline-Objᵢ-L
where, when the y^{th} row of the image is currently being inspected, Seg-L represents the X-axis coordinate of a left start point of the newly detected linear image segment found in the y^{th} row; Preline-Objᵢ-R represents the X-axis coordinate of a right end point of a previously detected linear image segment of the object i that was found in the (y−1)^{th} row of the image; Seg-R represents the X-axis coordinate of a right end point of the newly detected linear image segment found in the y^{th} row; and Preline-Objᵢ-L represents the X-axis coordinate of a left start point of the previously detected linear image segment of the object i that was found in the (y−1)^{th} row.

6. A system for recognizing objects in an image, comprising:
an image sensor including a plurality of pixel sensing elements arranged in rows and capable of sensing the image in a row-by-row manner such that linear image segments of the objects in the image captured by said image sensor are sensed by corresponding rows of said pixel sensing elements, said image sensor outputting said linear image segments as an analog output;
an analog-to-digital converter connected to said image sensor for converting the analog output to a digital output;
an image processor connected to said analog-to-digital converter and collecting information of the linear image segments from the digital output, said image processor being set with a grayscale threshold value of the image; and
a register connected to said image processor for temporary storage of the information of the objects collected by said image processor;
wherein said image processor identifies a background region and the linear image segments in the image according to the grayscale threshold value, identifies the object to which a newly detected linear image segment located in a currently inspected row of the image belongs according to a spatial correlation between the newly detected linear image segment and a previously detected linear image segment in an adjacent previously inspected row of the image, associates the collected information of the linear image segments with the identified objects, and distinguishes the identified objects from each other based on at least one object characteristic.

7. The system as claimed in claim 6, wherein the object characteristic is one of solid, ring-shaped, long and short characteristics.

8. The system as claimed in claim 6, further comprising an interface module connected to said image processor and adapted for outputting information related to the identified objects to a transmission interface of a computer in a data format compliant with a peripheral protocol of the computer for enabling the computer to display the identified objects on a display of the computer.
